(19) United States
(12) Patent Application Publication
(10) Pub. No.: US 2020/0111042 A1
(43) Pub. Date: Apr. 9, 2020

(54) TECHNIQUES TO ENHANCE EMPLOYEE PERFORMANCE USING MACHINE LEARNING

(71) Applicant: Capital One Services, LLC, McLean, VA (US)

(72) Inventors: Vincent PHAM, Champaign, IL (US); Austin Grant WALTERS, Savoy, IL (US); Jeremy Edward GOODSITT, Champaign, IL (US); Fardin ABDI TAGHI ABAD, Champaign, IL (US); Kenneth TAYLOR, Champaign, IL (US); Anh TRUONG, Champaign, IL (US); Kate KEY, Effingham, IL (US)

(73) Assignee: Capital One Services, LLC, McLean, VA (US)

(21) Appl. No.: 16/152,081

(22) Filed: Oct. 4, 2018

(51) Int. Cl. G06Q 10/06; G06N 99/00

(52) U.S. Cl. CPC G06Q 10/06398; G06N 99/005

(57) ABSTRACT

Techniques to enhance employee performance using machine learning are described. In some embodiments, these techniques are directed to rendering recommendations to employee reviews by processing, via an input device, an employee review between a manager and an employee, the employee review comprising employee-related remarks by the manager, using the machine learning model to identify at least one employee-related remark of the employee review to have a negative impact on employee performance, the negative impact being attributed to a reviewer type of the manager or a personality type of the employee, and displaying, on an output device, an annotated employee review wherein the annotated employee review comprises the employee review and data indicating that the at least one employee-related remark is likely to result in the negative impact. Other embodiments are described and claimed.

### BACKGROUND

Employers are constantly seeking new and/or effective tools to enhance employee performance in some meaningful manner. The communications between a manager and an employee can be critical to that employee's effort level. When those communications are not handled properly or not well-received by the employee, it can be disastrous for both the employee and the employer. As an example, managers routinely find difficult the actual process of writing performance reviews of employees, resulting in generic reviews that are meaningless to the employee or bad reviews that do not positively affect employee performance.

It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to enhance employee performance using machine leaning. Some embodiments are particularly directed to techniques to enhance employee performance using machine leaning for improving employee reviews. In one embodiment, for example, an apparatus may include a logic circuit and logic stored in a memory unit and operative on the logic circuit to process a historical employee dataset including historical employee review data and historical employee performance data. The historical employee dataset further includes at least one employee cluster of which each employee cluster corresponds to a personality type and at least one manager cluster of which each manager cluster corresponds to a reviewer type.

The logic may be further operative to train a machine learning model from the historical employee dataset to determine a first set of employee-related remarks having a negative impact on employee performance based upon a reviewer type data point or a personality type data point and a second set of employee-related remarks having a positive impact on employee performance based upon a reviewer type data point or a personality type data point and process, via an input device, an employee review between a manager and an employee where the employee review includes employee-related remarks by the manager. The logic may be further operative to use the machine learning model to identify at least one employee-related remark of the employee review to have a negative impact on employee performance, the negative impact being attributed to a reviewer type of the manager or a personality type of the employee and display, on an output device, an annotated employee review wherein the annotated employee review comprises the employee review and data indicating that the at least one employee-related remark is likely to result in the negative impact. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to enhance employee performance using machine learning.

FIG. 2 illustrates an embodiment of an apparatus in a system to enhance employee performance using machine learning.

FIGS. 3A-C illustrate embodiments of an operating environment for the apparatus.

FIG. 4 illustrates an embodiment of a logic flow for the system of FIG. 1.

FIG. 5 illustrates an embodiment of a second logic flow for the system of FIG. 1.

FIG. 6 illustrates an embodiment of a third logic flow for the system of FIG. 1.

FIG. 7 illustrates an embodiment of a fourth logic flow for the system of FIG. 1.

FIG. 8 illustrates an embodiment of a computing architecture.

FIG. 9 illustrates an embodiment of a communications architecture.

### DETAILED DESCRIPTION

Various embodiments are directed to enhancing employee performance using machine learning by recommending modifications to employee reviews based upon whether an employee-related remark is likely to result in a negative impact on employee performance.

Some of these embodiments are further directed to: process a historical employee dataset comprising historical employee review data and historical employee performance data, the historical employee dataset further comprising at least one employee cluster of which each employee cluster corresponds to a personality type and at least one manager cluster of which each manager cluster corresponds to a reviewer type; train a machine learning model from the historical employee dataset to determine a first set of employee-related remarks having a negative impact on employee performance based upon a reviewer type data point or a personality type data point and a second set of employee-related remarks having a positive impact on employee performance based upon a reviewer type data point or a personality type data point; process, via an input device, an employee review between a manager and an employee, the employee review comprising employee-related remarks by the manager; use the machine learning model to identify at least one employee-related remark of the employee review to have a negative impact on employee performance, the negative impact being attributed to a reviewer type of the manager or a personality type of the employee; and display, on an output device, an annotated employee review wherein the annotated employee review comprises the employee review and data indicating that the at least one employee-related remark is likely to result in the negative impact. As a result, the embodiments can improve affordability, scalability, modularity, extendibility, or interoperability for an operator, device or network.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. The intention is to cover all modifications, equivalents, and alternatives consistent with the claimed subject matter.

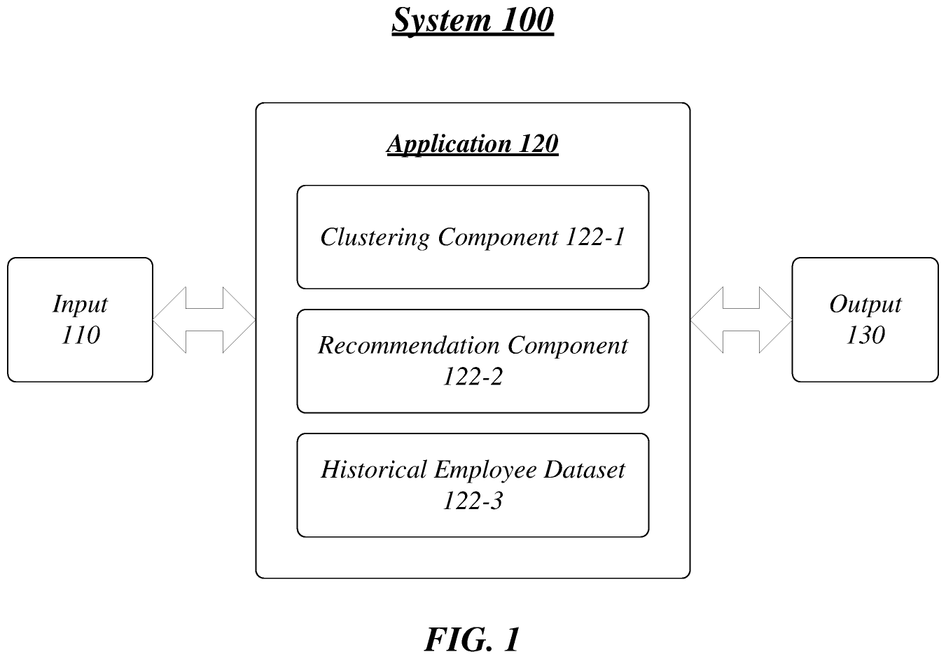

FIG. 1 illustrates a block diagram for a system 100. In one embodiment, the system 100 may comprise a computer-implemented system 100 having an application 120 comprising one or more components 122-a. Although the system 100 shown in FIG. 1 has a limited number of elements in a certain topology, it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not the limited in this context.

The system 100 may comprise the application 120 to implement logic operative on a logic circuit to transform an employee review and input 110 into output 130 comprising, in part, an annotated employee review as described in further detail herein.

The application 120 may include a clustering component 122-1 and a recommendation component 122-2. The clustering component 122-1 may be generally arranged to process a historical employee dataset 122-3 comprising historical employee review data and historical employee performance data, the historical employee dataset 122-3 further comprising at least one employee cluster of which each employee has a personality type and at least one manager cluster of which each manager has a reviewer type. It is appreciated that the historical employee review data includes historical reviews made by other managers and the historical employee performance data includes various measures of employee activities.

The clustering component 122-1 may be further configured to train a machine learning model from the historical employee dataset 122-3 to determine a first set of employee-related remarks having a negative impact on employee performance based upon a reviewer type data point or a personality type data point and a second set of employee-related remarks having a positive impact on employee performance based upon a reviewer type data point or a personality type data point. The clustering component 122-1 executes such training by assigning values and weights to data points and correlates a combined value to a discernable impact on employee performance.

The recommendation component 122-2 of the application 120 may be generally arranged to process, via an input device, input including an employee review between a manager and an employee and comprising employee-related remarks by the manager. In some embodiments, following the processing of the employee review, the apparatus 120 receives a control directive to use a machine learning model to identify at least one employee-related remark of the above-mentioned employee review to have a negative impact on employee performance, the negative impact being attributed to a reviewer type of the manager or a personality type of the employee. The apparatus 120 then instructs an output device (e.g., a display device) to display the annotated employee review wherein the annotated employee review comprises the employee review and data (e.g., message data) indicating that the at least one employee-related remark is likely to result in the negative impact. The present disclosure also describes a machine learning model operative to (possibly) identify an employee-related remark of the above-mentioned employee review to have a positive impact on employee performance.

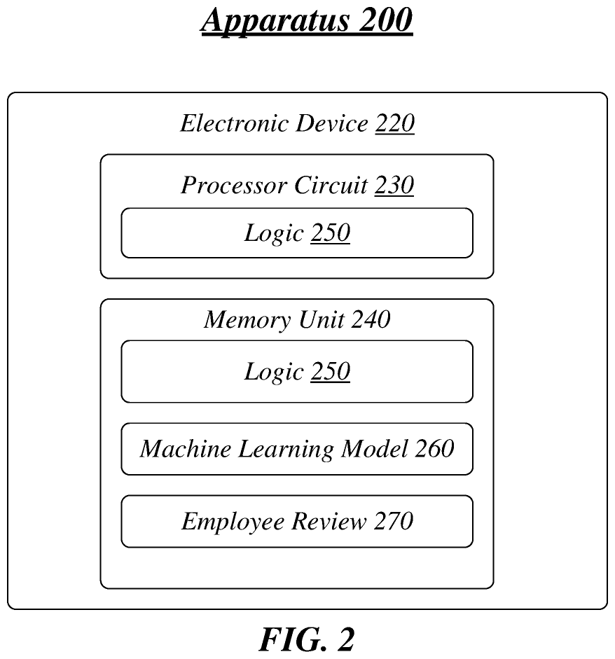

FIG. 2 illustrates an embodiment of an apparatus 200 for the system 100. The apparatus 200 may implement some or all of the structure and/or operations of the system 100 in a single computing entity, such as within a single electronic device 220.

The device 220 may comprise any electronic device capable of receiving, processing, and sending information for the system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 220 may execute processing operations or logic for the system 100 using a processor circuit 230. The processor circuit 230 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), Application-specific Standard Products (ASSPs), System-on-a-chip systems (SOCs), Complex Programmable Logic Devices (CPLDs), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. The device 820 may communicate with other devices over a communications media respectively, using communications hardware.

As shown in FIG. 2, the apparatus 200 may be implemented as the electronic device 220 comprising the processor circuit 230 as a logic circuit and a memory unit 240 as data storage. The memory unit 240 stores logic 250 that is operative on the processor circuit 230 to execute various functionality, as described herein. The memory unit 240 further includes a machine learning model 260 and an employee review 270.

In some embodiments, the logic 250 is executed to train the machine learning model 260 from a historical employee dataset comprising historical employee review data and historical employee performance data. Such training may be based upon inputs, such as data points comprising either a personality type of the employee or a reviewer type of the manager, or both, and an employee-related remark. The logic 250 may assign values to such inputs to correlate either the personality type of the employee or the reviewer type of the manager, or both to a negative impact on employee performance. As described herein, a number of different measures may be combined to indicate employee performance for a given time period; one such measure includes a level of employee effort. The logic 250 may implement a learning technique such that values attributed to these data points properly determine whether a remark in the employee review 270 is likely to result in a negative performance, for example, in the form of decreased email activity and/or lower-quality work.

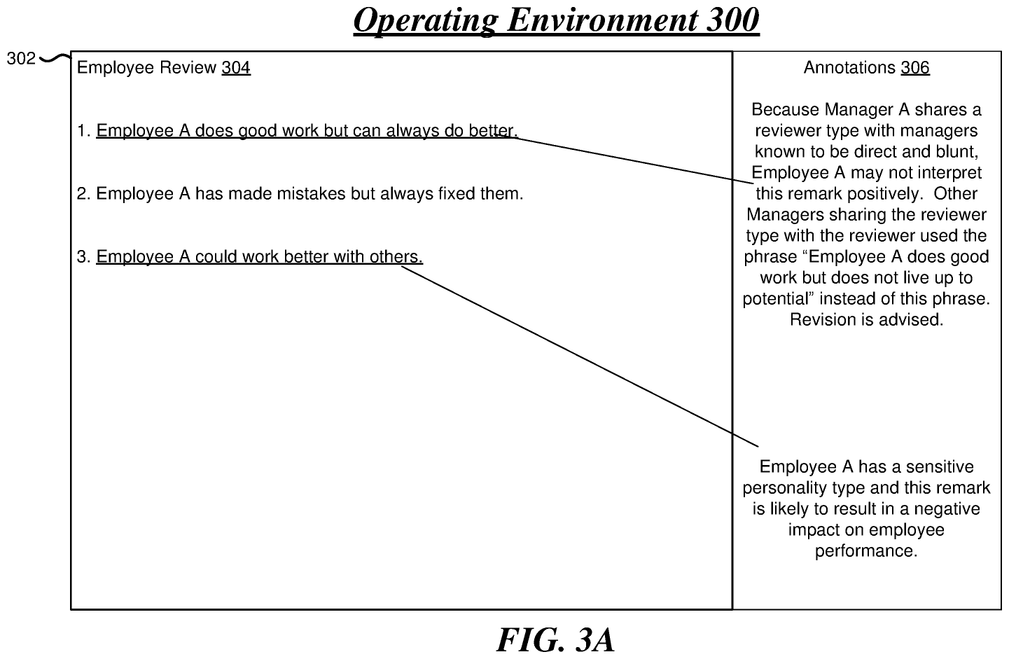

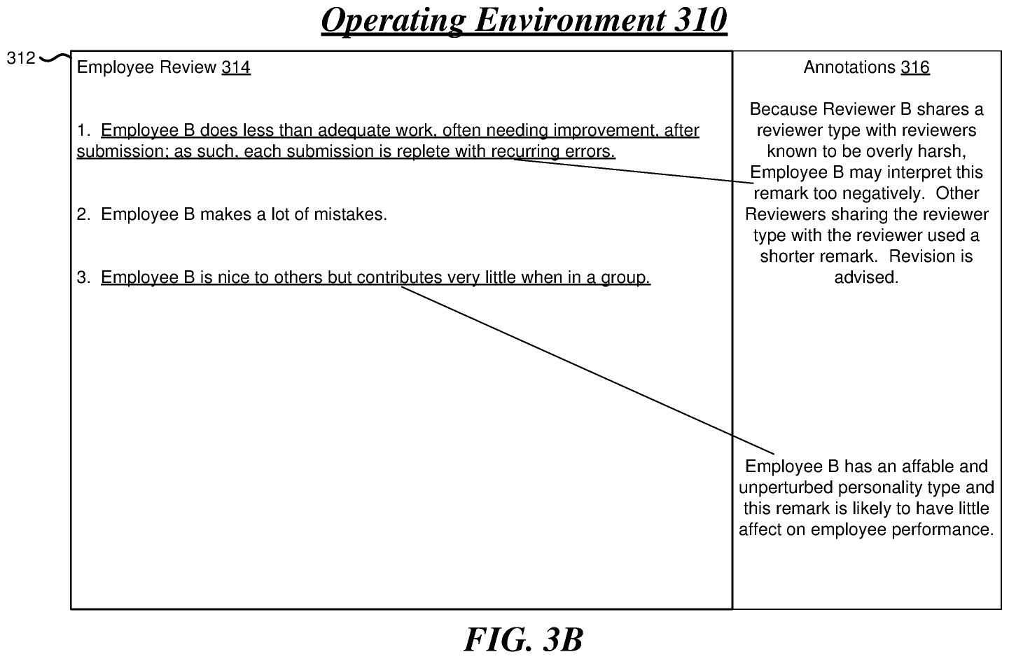

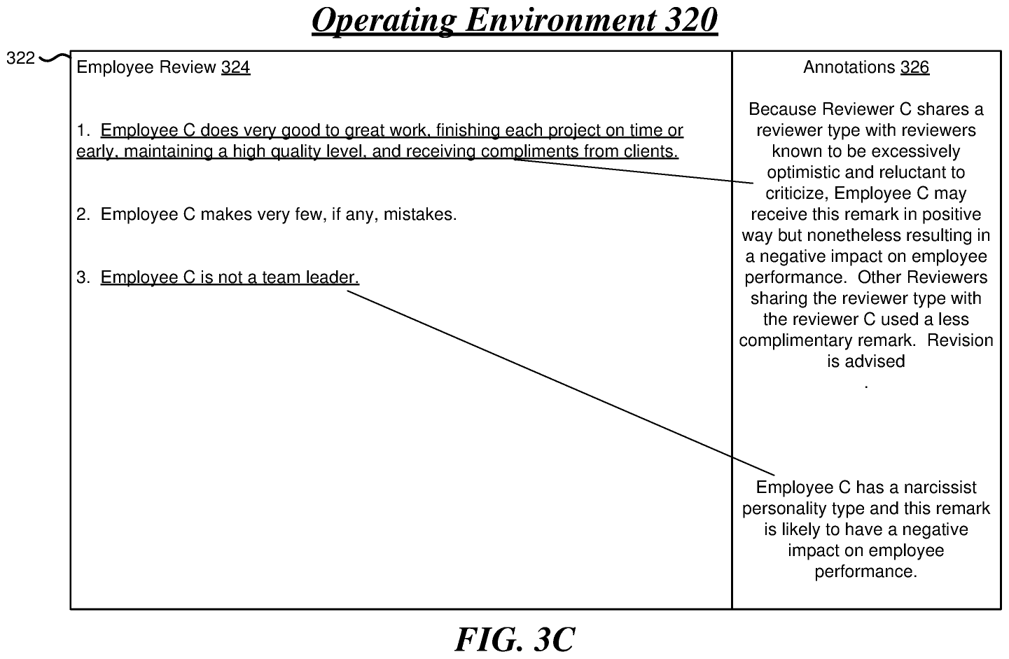

FIG. 3A illustrates an embodiment of an operating environment 300 for the system 100. As shown in FIG. 3A, the operating environment 300 provides a graphical user interface (GUI) 302 for display on an output device, such as a computer screen. The GUI 302 depicts an employee review 304 comprising three remarks (i.e., employee-related remarks) made by Manager A about Employee A. The GUI 302 further includes annotations 306 generated by the system 100.

In some embodiments, the system 100 processes input comprising the three employee-related remarks, a reviewer type of the manager, and a personality type of the employee and, based upon a machine learning model, identifies one or more remarks likely to have a negative impact on employee performance. In FIG. 3A, the first remark of “Employee A does good work but can always do better” is likely to result in a negative impact on employee performance and this impact is attributed (at least in part) to the manager having a direct and blunt reviewer type. As demonstrated herein, the machine learning model may indicate that managers having a direct and blunt reviewer type who use the above remark are likely to cause a statistically significant decrease in employee performance.

In some embodiments, the system 100 may execute logic to recommend an alternative phrasing: “Employee A does good work but does not live up to potential.” As demonstrated herein, the machine learning model may indicate that managers having a direct and blunt reviewer type who use the above remark instead of the first remark are not likely to cause a negative impact on employee performance. The GUI 302 enables editing of the employee review 304 to allow for the replacement of the first remark with the alternative phrasing.

In some embodiments, the system 100 processes a second remark of “Employee A has made mistakes but always fixed them” and, based upon the machine learning model, determines that the second remark is not likely to result in a negative impact on employee performance. Even when the second remark is made by managers having a direct and blunt reviewer type, the machine learning model indicates that the second remark in the employee review 304 is not likely to result in a negative impact on employee performance.

In some embodiments, the system 100 processes a third remark of “Employee A could work better with others.” Given that the employee has a sensitive personality type, the third remark may be interpreted in a negative light and thus, may result in a negative impact on employee performance.

FIG. 3B illustrates an embodiment of an operating environment 310 for the system 100. As shown in FIG. 3, the operating environment 310 provides a graphical user interface (GUI) 312 for display on an output device, such as a computer screen. The GUI 312 depicts an employee review 314 comprising three remarks (i.e., employee-related remarks) made by Manager B about Employee B. The GUI 312 further includes annotations 316 generated by the system 100.

In some embodiments, one or more components of the system 100 execute logic to process input comprising the three employee-related remarks, a reviewer type of the manager, and a personality type of the employee and, based upon a machine learning model, identify one or more remarks likely to have a negative impact on employee performance. In FIG. 3B, the first remark of “Employee B does less than adequate work, often needing improvement, after submission; as such, each submission is replete with recurring errors” is likely to result in a negative impact on employee performance and this impact is attributed (at least in part) to the manager having an overly harsh reviewer type. As demonstrated herein, the machine learning model may indicate that managers having an overly harsh reviewer type who use the above remark are likely to cause a statistically significant decrease in employee performance.

In some embodiments, one or more components of the system 100 execute logic to recommend a shorter remark to replace the first remark. As demonstrated herein, the machine learning model may indicate that managers having an overly harsh reviewer type who use the shorter remark are not likely to cause a negative impact on employee performance. The GUI 312 enables editing of the employee review 314 to allow for the replacement of the first remark with the shorter remark.

In some embodiments, the system 100 processes a second remark of “Employee B makes a lot of mistakes” and, based upon the machine learning model, determines that the second remark is not likely to result in a negative impact on employee performance. Even when the second remark is made by managers having an overly harsh reviewer type, the machine learning model indicates that the second remark in the employee review 314 is not likely to result in a negative impact on employee performance.

In some embodiments, the system 100 processes a third remark of “Employee B is nice to others but contributes very little when in a group.” Given that the employee has a sensitive personality type, the machine learning model indicates that the third remark may be interpreted in a negative light and thus, may result in a negative impact on employee performance.

FIG. 3C illustrates an embodiment of an operating environment 320 for the system 100. As shown in FIG. 3C, the operating environment 320 provides a graphical user interface (GUI) 322 for display on an output device, such as a computer screen. The GUI 302 depicts an employee review 324 comprising three remarks made by a manager about an employee (i.e., employee-related remarks) and annotations 326 generated by the system 100.

In some embodiments, the system 100 processes input comprising the three employee-related remarks, a reviewer type of the manager, and a personality type of the employee and, based upon a machine learning model, identifies one or more remarks likely to have a negative impact on employee performance. In FIG. 3C, the first remark of “Employee C does very good to great work, finishing each project on time or early, maintaining a high quality level, and receiving compliments from clients” is likely to result in a negative impact on employee performance and this impact is attributed (at least in part) to the manager having an excessively optimistic and reluctant to criticize reviewer type. As demonstrated herein, the machine learning model may indicate that managers having such a excessively optimistic and reluctant to criticize reviewer type who use the above remark are likely to cause a statistically significant decrease in employee effort. This is due at least in part to the fact that the Employee C feels like they can work a slower and achieve the same remark.

In some embodiments, the system 100 processes a second remark of “Employee C makes very few, if any, mistakes” and, based upon the machine learning model, determines that the second remark is not likely to result in a negative impact on employee performance. Even when the second remark is made by managers having an excessively optimistic and reluctant to criticize reviewer type, the machine learning model indicates that the second remark in the employee review 324 is not likely to result in a negative impact on employee performance.

In some embodiments, the system 100 processes a third remark of “Employee C is not a team leader.” Given that the employee has a narcissist personality type, the machine learning model indicates that the third remark may be interpreted in a negative light and thus, may result in a negative impact on employee performance.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

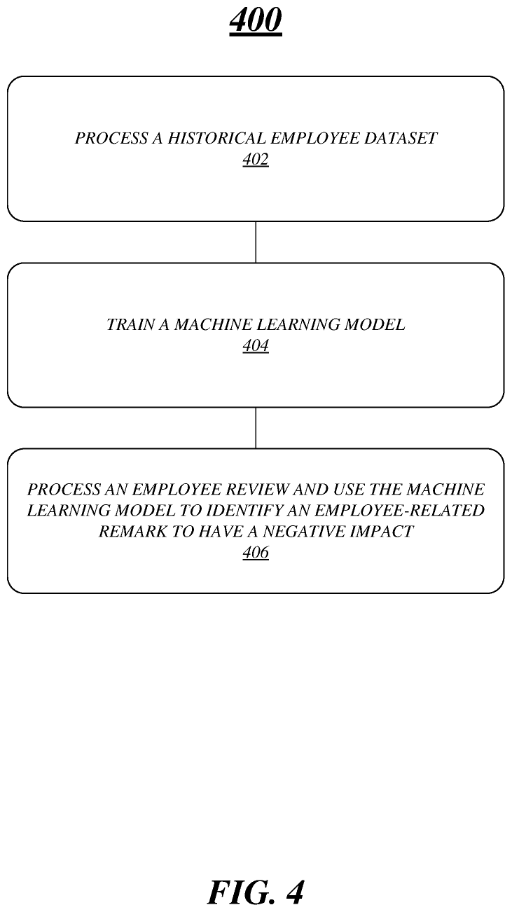

FIG. 4 illustrates one embodiment of a logic flow 400. The logic flow 400 may be representative of some or all of the operations executed by one or more embodiments described herein.

In the illustrated embodiment shown in FIG. 4, the logic flow 400 processes a historical employee dataset at block 402. For example, the historical employee dataset includes historical employee review data and historical employee performance data. The historical employee dataset further includes data identifying employee clusters and a personality type for each employee cluster and data identifying manager clusters and a reviewer type for each manager cluster.

The logic flow 400 may train a machine learning model at block 404. For example, the system 100 may generate the machine learning model to determine a historical employee review is likely to result in a negative impact on employee performance when given the personality type of the historical employee review's employee and/or the reviewer type of the historical employee review's manager. The training of the machine learning model includes assigning values to input data points (e.g., the employee-related remark and the personality type and/or the reviewer type) and assigning weights to those values. The training further includes correlating a cumulative value corresponding to these data points to a discernable impact (e.g., a negative impact or a positive impact) on employee performance. For example, by using either or both the personality type of the employee and the reviewer type of the manager as data points, the machine learning model correlates either one or both of these data points to a negative impact on employee performance after a particular employee-related remark.

The logic flow 400 may process an employee review and use the machine learning model to identify an employee-related remark to have a negative impact at block 406. As described herein, a manager may produce the employee review by entering employee-related remarks through the system 100. When given the reviewer type of the manager or the personality type of the employee, the logic flow 400 determines whether one or more of the employee-related remarks is likely to have a negative impact on employee performance. The embodiments are not limited to this example.

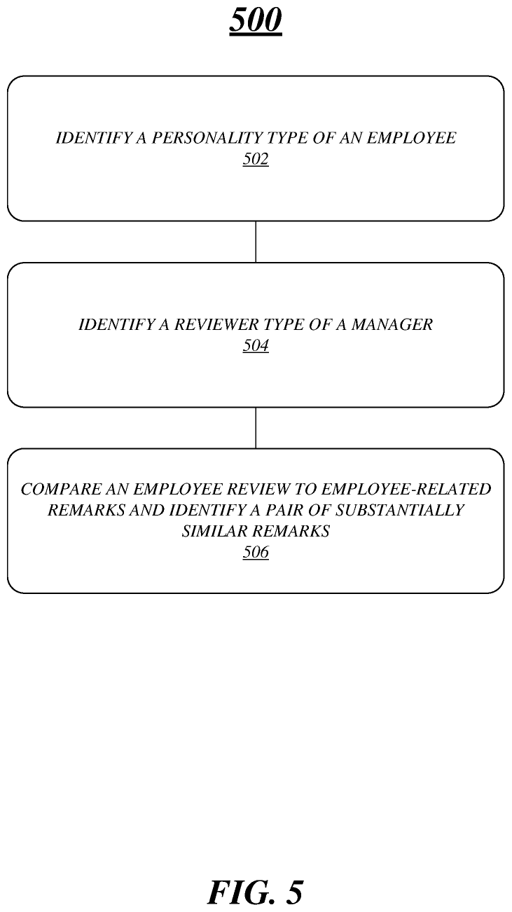

FIG. 5 illustrates one embodiment of a logic flow 500. The logic flow 500 may be representative of some or all of the operations executed by one or more embodiments described herein.

In the illustrated embodiment shown in FIG. 5, the logic flow 500 processes an employee review between a manager and an employee and uses a machine learning model to determine whether the employee review is likely to result in a negative impact on employee performance. The logic flow 500 may identify a personality type of an employee at block 502. For example, the logic flow 500 may analyze communications made by the employee and identify the personality type of the employee to be sensitive.

The logic flow 500 may identify a reviewer type of a manager at block 504. For example, the logic flow 500 may analyze communications made by the employee and identify the personality type of the manager to be overly critical and harsh. The manager may be grouped into a cluster with other managers with an overly critical and harsh reviewer type. Based upon a measurable negative impact on employee performance made by these managers and their remarks in historical employee reviews, the logic flow 500 may use the machine learning model to determine whether a sensitive employee also is likely to have a negative impact on their performance.

The logic flow 500 may compare contents of an employee review to a set of employee-related remarks likely to have a negative impact on employee performance and identify a pair of substantially similar remarks at block 506. The logic flow 500 may determine whether the employee review is likely to result in a negative impact, no impact, or a positive impact on employee performance at block 508. The embodiments are not limited to this example.

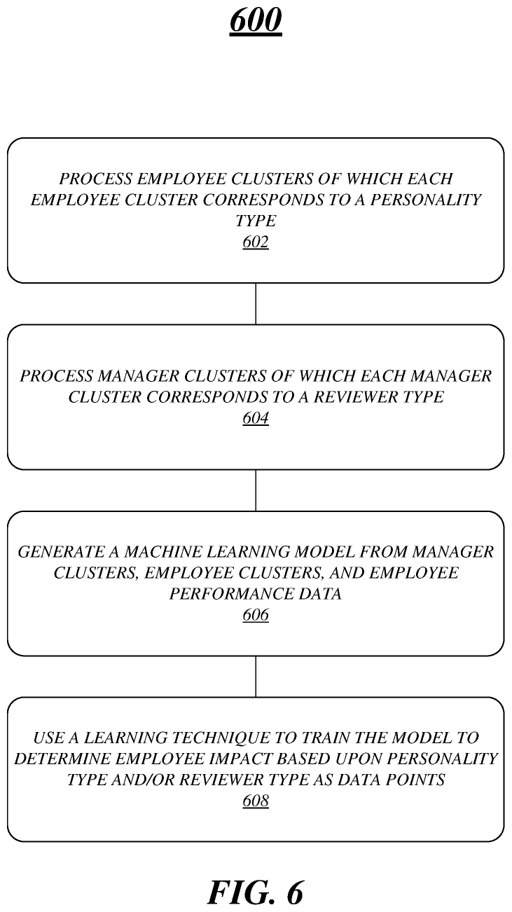

FIG. 6 illustrates one embodiment of a logic flow 600. The logic flow 600 may be representative of some or all of the operations executed by one or more embodiments described herein.

In the illustrated embodiment shown in FIG. 6, the logic flow 600 processes employee clusters of which employee clusters corresponds to a personality type at block 602. For example, each employee cluster includes employees sharing the same personality type based upon behavior indicators gathered from each employee's communications.

The logic flow 600 may process manager clusters of which each manager cluster corresponds to a reviewer type at block 604. For example, each reviewer cluster includes managers sharing the same reviewer type based upon remarks made in historical reviews.

The logic flow 600 may generate a machine learning model from manager clusters, employee clusters, and employee performance data at block 606. For example, the logic flow 600 may assign different values to different manager clusters where each cluster's value is a statistic (e.g., a probability) representing whether or not a particular remark from someone in that cluster is likely to result in a negative impact on performance.

The logic flow 600 may use a learning technique to train the model to determine employee performance impact attributed to personality type and/or reviewer type as data points at block 608. For example, the logic flow 600 may correlate a negative impact on employee performance to a particularly harsh review made by an overly harsh reviewer. As another example, the logic flow 600 may classify remarks in a review made to employees with a sensitive personality type as having a negative impact because such employees, in general, take any criticism negatively.

Some example embodiments for training the model at block 608 employ the “Term Frequency-Inverse Document Frequency” (TF-IDF) technique to distinguish important words or n-grams from unimportant ones. Some important words or n-grams are likely to motivate or demotivate an employee according to that employee's cluster and its associated personality type. Various measures may be utilized for identifying words or n-grams that are likely to motivate/demotivate, such as whether, after receiving certain words or n-grams in a review, the employee received a promotion/demotion, voluntary left the company, was involuntarily fired, changed teams, and/or the like.

Some other example embodiments for training the model at block 608 utilize the Long Term-Short Term frequency (LSTM) technique, which is a neural network approach to learn the constructive sentences and the non-constructive sentences in reviews. Similar to the approach for TF-IDF, the LSTM technique utilizes various measures for determining whether certain sentences are likely to motivate/demotivate an employee. Another example embodiment encodes certain words to use as predictor(s) into models employing linear regression, random forest, and other machine learning techniques. The embodiments are not limited to this example.

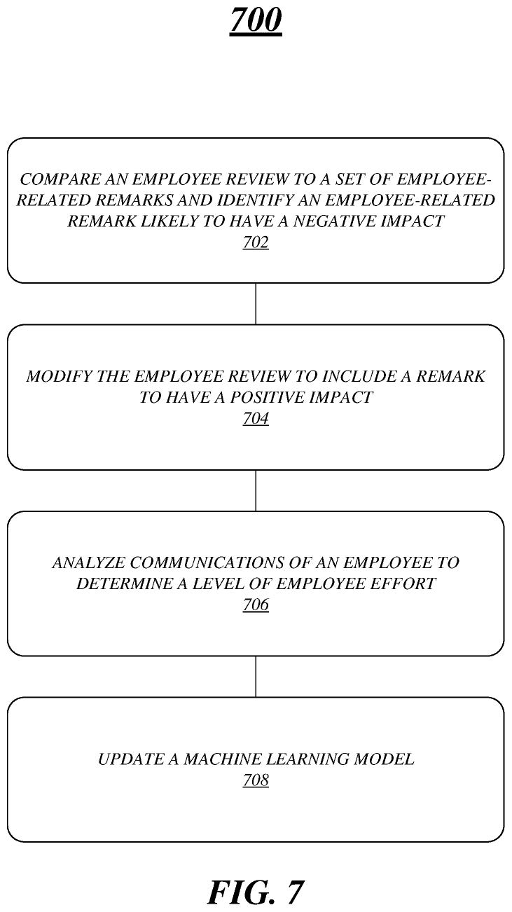

FIG. 7 illustrates one embodiment of a logic flow 700. The logic flow 700 may be representative of some or all of the operations executed by one or more embodiments described herein.

In the illustrated embodiment shown in FIG. 7, the logic flow 700 compares an employee review to a set of employee-related remarks and identifies an employee-related remark likely to have a negative impact on employee performance as at block 702.

The logic flow 700 may modify the employee review to include a remark to have a positive impact on employee performance at block 704. For example, the logic flow 700 may identify an alternative phrasing of the above-identified employee-related remark, and because such a phrasing is likely to result in a positive impact on employee performance, the logic flow 700 replaces the employee-related remark with the alternative phrasing. As another example, the logic flow 700 may remove the above-identified employee-related remark if other remarks are likely to have a positive impact.

The logic flow 700 may analyze communications of an employee to determine a level of employee effort at block 706. As one example measure of employee performance, the level of employee effort provides an indicator of employee activities (e.g., employee communications via e-mail, text message, voice/video call, and/or the like). The level of employee effort is a reliable indicator of at least an implicit reaction to the employee review.

The logic flow 700 may update a machine learning model at block 708. For example, if the level of employee effort increases significantly, the logic flow 700 may fit the machine learning model's weights such that the employee review's reviewer type and/or personality type may be used as data points for identifying such a positive impact for that particular review. This may occur when the employee increases email activity and participates in group activities where such activities influence the measured level of employee effort. On the other hand, if the level of employee effort decreases significantly, the logic flow 700 may fit the machine learning model's weights such that the employee review's reviewer type and/or personality type may be used as data points for identifying that negative impact on employee performance. This may occur when the employee decreases email activity and neglects group activities where such activities influence the measured level of employee effort. The embodiments are not limited to this example.

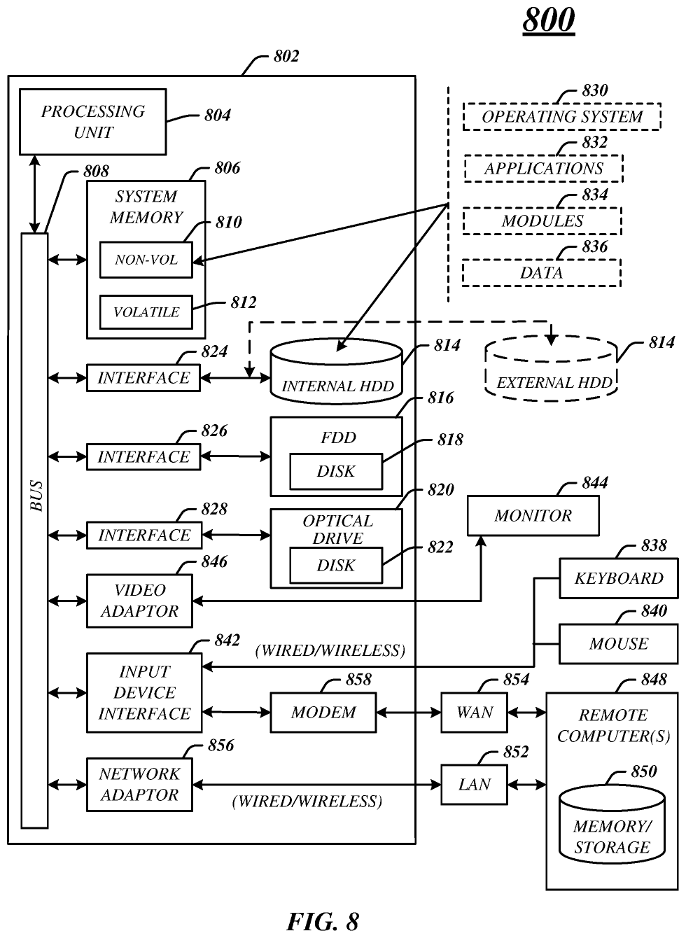

FIG. 8 illustrates an embodiment of an exemplary computing architecture 800 suitable for implementing various embodiments as previously described. In one embodiment, the computing architecture 800 may comprise or be implemented as part of an electronic device. Examples of an electronic device may include those described with reference to FIG. 2, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

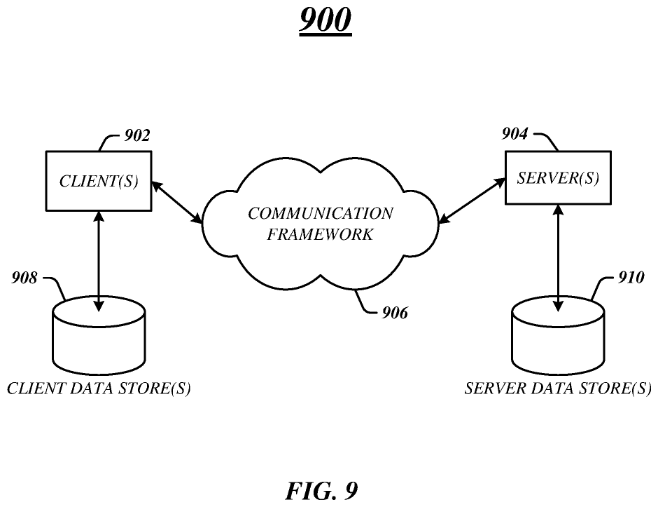

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 may implement the client device 910. The servers 904 may implement the server device 950. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic circuit; and
logic stored in a memory unit and operative on the logic circuit to:
process a historical employee dataset stored in the memory unit comprising historical employee review data and historical employee performance data, the historical employee dataset further comprising at least one manager cluster of which each manager cluster corresponds to a reviewer type;
train a machine learning model from the historical employee dataset to determine a first set of employee-related remarks having a negative impact on employee performance based upon a reviewer type data point and a second set of employee-related remarks having a positive impact on employee performance based upon a reviewer type data point or a personality type data point;
process, via an input device, an employee review between a manager and an employee, the employee review comprising employee-related remarks by the manager;
use the machine learning model to identify at least one employee-related remark of the employee review to have a negative impact on employee performance, the negative impact being attributed to a reviewer type of the manager; and
display, on an output device, an annotated employee review wherein the annotated employee review comprises the employee review and data indicating that the at least one employee-related remark is likely to result in the negative impact.

2. The apparatus of claim 1, comprising logic operative on the logic circuit to use the machine learning model to identify at least one employee-related remark of the employee review to have a positive impact on employee performance, the positive impact being attributed to a reviewer type of the manager.

3. The apparatus of claim 1, comprising logic operative on the logic circuit to compare the employee-related remarks of the employee review to the first set of employee-related remarks and determine that the at least one identified employee-related remark is substantially similar to at least one of the first set of employee-related remarks.

4. The apparatus of claim 1, comprising logic operative on the logic circuit to analyzing communications of the employee to determine a level of employee effort after the employee review.

5. The apparatus of claim 4, comprising logic operative on the logic circuit to update the machine learning model with the annotated employee review and the level of employee effort.

6. The apparatus of claim 1, comprising logic operative on the logic circuit to identify a personality type of the employee based upon behavior indicators corresponding to employee communications.

7. The apparatus of claim 1, comprising logic operative on the logic circuit to identify the reviewer type of the manager based upon review similarity between the employee review and the historical employee review data.

8. A computer-implemented method executed on at least one processor circuit, comprising:
processing a historical employee dataset stored in a memory unit comprising historical employee review data and historical employee performance data, the historical employee dataset further comprising at least one manager cluster of which each manager cluster corresponds a reviewer type;
training a machine learning model from the historical employee dataset to determine a first set of employee-related remarks having a negative impact on employee performance based upon a reviewer type data point and a second set of employee-related remarks having a positive impact on employee performance based upon a reviewer type data point;
processing an employee review between a manager and an employee, the employee review comprising employee-related remarks by the manager;
using the machine learning model to identify at least one employee-related remark of the employee review to have a negative impact on employee performance, the negative impact being attributed to a reviewer type of the manager; and
displaying, on an output device, an annotated employee review wherein the annotated employee review comprises the employee review and data indicating that the at least one employee-related remark is likely to result in the negative impact.

9. The computer-implemented method of claim 8, comprising comparing the employee-related remarks to the first set of employee-related remarks and identify a pair of substantially similar employee-related remarks.

10. The computer-implemented method of claim 9, comprising using the machine learning model to identify at least one employee-related remark of the employee review to have a negative impact on employee performance, the negative impact being attributed to a reviewer type of the manager or a personality type of the employee.

11. The computer-implemented method of claim 8, comprising analyzing communications of the employee to determine a level of employee effort after the employee review.

12. The computer-implemented method of claim 11, comprising updating the machine learning model with the annotated employee review and the level of employee effort.

13. The computer-implemented method of claim 8, comprising identifying the personality type of the employee based upon behavior indicators corresponding to employee communications.

14. The computer-implemented method of claim 8, comprising identifying the reviewer type of the manager based upon review similarity between the employee review and the historical employee review data.

15. At least one computer-readable storage medium comprising instructions that, when executed, cause a system to:
process a historical employee dataset comprising historical employee review data and historical employee performance data, the historical employee dataset further comprising at least one manager cluster of which each manager has a reviewer type;
train a machine learning model from the historical employee dataset to determine a first set of employee-related remarks having a negative impact on employee performance based upon a reviewer type data point and a second set of employee-related remarks having a positive impact on employee performance based upon a reviewer type data point;
process an employee review between a manager and an employee, the employee review comprising employee-related remarks by the manager;
use the machine learning model to identify at least one employee-related remark of the employee review to have a negative impact on employee performance, the negative impact being attributed to a reviewer type of the manager; and
display an annotated employee review on an output device wherein the annotated employee review comprises the employee review and data indicating that the at least one employee-related remark is likely to result in the negative impact.

16. The computer-readable storage medium of claim 15, comprising instructions that when executed cause the system to determine that the at least one identified employee-related remark is substantially similar to at least one of the first set of employee-related remarks.

17. The computer-readable storage medium of claim 15, comprising instructions that when executed cause the system to comprising analyzing communications of the employee to determine a level of employee effort after the employee review.

18. The computer-readable storage medium of claim 17, comprising instructions that when executed cause the system to update the machine learning model with the annotated employee review and the level of employee effort.

19. The computer-readable storage medium of claim 15, comprising instructions that when executed cause the system to identify the personality type of the employee based upon behavior indicators corresponding to employee communications.

20. The computer-readable storage medium of claim 15, comprising instructions that when executed cause the system to identify the reviewer type of the manager based upon review similarity between the employee review and the historical employee review data.
